(19) United States
(12) Patent Application Publication
(10) Pub. No.: US 2004/0111887 A1
(43) Pub. Date: Jun. 17, 2004

(54) Method for filling heat pipe wick structure and the like

(76) Inventor: Hul Chun Hsu, Taipei (TW)

Correspondence Address: HUL CHUN HSU, P.O. BOX 26-757, TAIPEI, 106, TW

(21) Appl. No.: 10/729,063

(22) Filed: Dec. 5, 2003

(30) Foreign Application Priority Data
Dec. 6, 2002 (TW) 91135487

(51) Int. Cl. B23P 15/26

(52) U.S. Cl. 29/890.032

(57) ABSTRACT

A method for installing heat pipe wick structures and the like is described. The method provides a rod clamping wick structures and penetrating through the heat pipe for installing the wick structures in a heat pipe, and includes steps of (a) fabricating the wick structures into an elongated continuous coil tape, (b) rolling an end of the coil tape in a width direction and clamping the coil tape to a rod, which has an external diameter originally narrower than an internal diameter of the heat pipe, and narrowing the end of the coil tape rolled to be smaller than the internal diameter of the heat pipe; (c) drawing the rod to carry the coil tape from an end of the heat pipe to an opposite end thereof, and installing the rolled coil tape in the heat pipe; and (d) cutting off the coil tape extending out from the heat pipe.

### BACKGROUND OF THE INVENTION

1. Field of the Invention

The present invention relates to a method for filling heat pipe wick structures and the like. The present invention is particularly adapted to a rod clamping a wick structure and then penetrating through a heat pipe and relates to an apparatus manufactured by the method.

2. Background of the Invention

A heat pipe provides high heat transfer capacity quickly and good thermal conductivity, is lightweight, has no moving parts and a simple structure, and applicable in many fields. A heat pipe can therefore remove a mass of heat and save electricity to meet the heat dissipation requirement of electronic products. In addition, the heat pipe includes a wick structure disposed on an interior surface thereof, such as a screen mesh, and the wick structure provides capillary action to transfer a working fluid therein.

However, a conventional process for disposing the wick structure in the heat pipe rolls the wick structure into a cylinder shape and then is disposed the rolled wick structure into the heat pipe by inserting the wick into one end of the heat pipe. The conventional process easily damages the wick structure. For example, the mesh is squeezed and consequentially broken, and difficulty of the procedure increases with the length of the wick structure.

Hence, an improvement in the prior art is required to overcome the disadvantages thereof.

### SUMMARY OF INVENTION

The primary object of the invention is therefore to specify a method for installing heat pipe wick structures and the like, and the method provides a rod to clamp the wick structure and penetrate through the heat pipe for installing the wick structure into the heat pipe.

The secondary object of the invention is therefore to specify a method for installing heat pipe wick structures and the like, for easily conducting the wick structure disposed in the heat pipe and avoiding the damages encountered in the conventional process.

According to the invention, this object is achieved by a method for installing a heat pipe wick structure, including:

(a) fabricating the wick structures into a first elongated continuous coil tape, the first coil tape having a width approximately same as a circumference of an internal diameter of the heat pipe;

(b) rolling an end of the first coil tape in a width direction and clamping the end of the first coil tape to an end of a rod, which has an external diameter originally narrower than the internal diameter of the heat pipe, and narrowing the end of the first coil tape rolled to be smaller than the internal diameter of the heat pipe;

(c) drawing the rod to carry the coil tape from an end of the heat pipe to an opposite end thereof, and installing the rolled first coil tape in the heat pipe; and

(d) cutting off the coil tape extending out of the heat pipe to finish the process of installing the wick structure in the heat pipe.

To provide a further understanding of the invention, the present invention provides an apparatus includes a base, a hauling mechanism, a fixed mechanism and at least two cutting-off mechanisms for completing the apparatus thereof. The base has a work path defined overhead. The hauling mechanism is disposed on the base and is movable around a termination of the work path. The hauling mechanism has an end connecting to an end of a rod, which extends along the work path, towards a start of the work path and has a clamping portion arranged at an opposite end. The fixed mechanism is disposed on the work path and orients the heat pipe on the work path. The two cutting-off mechanisms are arranged on the work path and are respectively adjacent to two opposing outlets of the heat pipe.

Examples of the more important features of the invention thus have been summarized rather broadly in order that the detailed description thereof that follows may be better understood, and in order that the contributions to the art may be appreciated. There are, of course, additional features of the invention that will be described hereinafter and which will form the subject of the claims appended hereto.

### BRIEF DESCRIPTION OF THE DRAWINGS

These and other features, aspects, and advantages of the present invention will become better understood with regard to the following description, appended claims, and accompanying drawings where:

FIG. 1 is a flow chart according to steps of the present invention;

FIG. 2 is a perspective view before a wick structure is installed in a heat pipe;

FIG. 3 is a perspective view after the wick structure is installed in the heat pipe;

FIG. 4a is a cross-sectional profile along 4a-4a according to the FIG. 2;

FIG. 4b is a cross-sectional profile along 4b-4b according to the FIG. 2;

FIG. 4c is a cross-sectional profile along 4c-4c according to the FIG. 2;

FIG. 5 is a perspective view before the wick structure and a supporting body filling in a heat pipe;

FIG. 6 is a perspective view after the wick structure and the supporting body filling in a heat pipe;

FIG. 7a is a cross-sectional profile along 7a-7a according to the FIG. 5;

FIG. 7b is a cross-sectional profile along 7b-7b according to the FIG. 5; and

FIG. 7c is a cross-sectional profile along 7c-7c according to the FIG. 5.

### DETAILED DESCRIPTION OF THE EMBODIMENTS

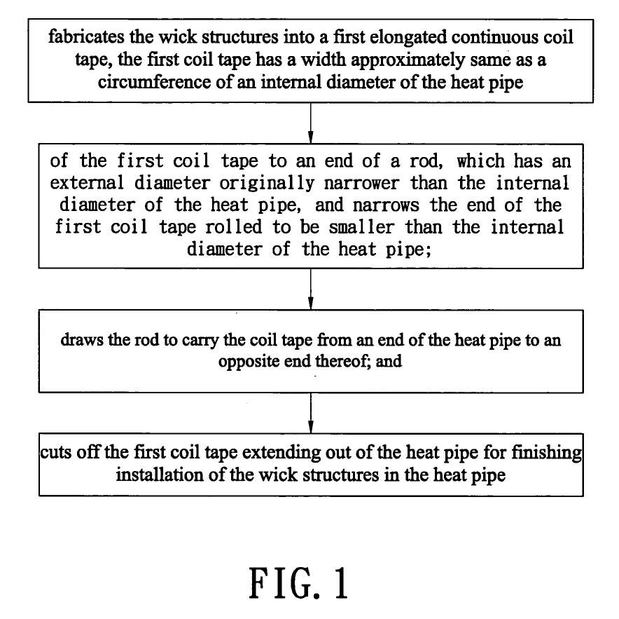

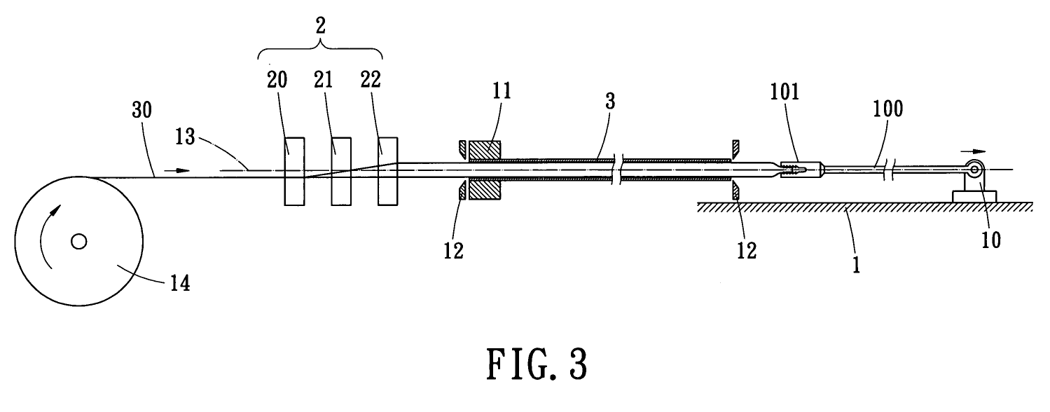

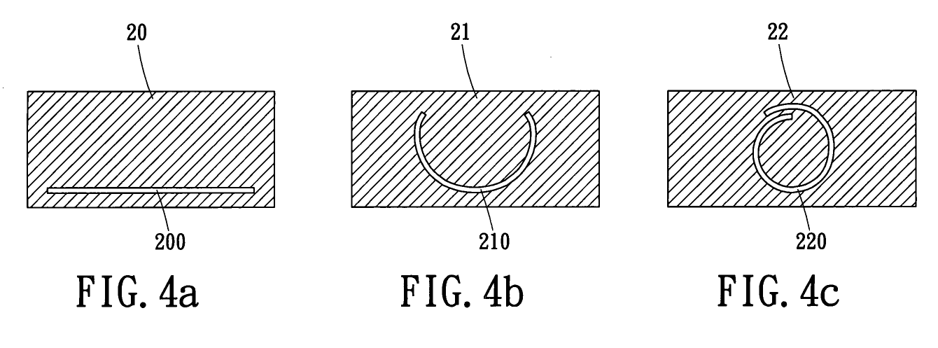

With respect to FIG. 1 and FIG. 3, the present invention respectively provides a flow chart according to steps thereof, a perspective view before a wick structure filling in a heat pipe, and a perspective view after the wick structure filling therein. The present invention provides a method for installing a plurality of wick structures 30 in a heat pipe 3. The method includes:

(a) fabricating the wick structures 30 into a first elongated continuous coil tape by rolling the first coil tape on a first reel 14 for continuous conducting, the first coil tape having a width approximately same as a circumference of an internal diameter of the heat pipe 3; accordingly, the wick structures 30 fully fill and retain against the internal diameter of the heat pipe 3;

(b) rolling an end of the first coil tape in a width direction and clamping the end of the first coil tape to an end of a rod 100, which has an external diameter originally narrower than the internal diameter of the heat pipe, 3 and narrowing the end of the rolled first coil tape to be smaller than the interns diameter of the heat pipe 3; the first coil tape is first rolled by a roll-forming mold 2 and then narrowed to be receivable by the outlet of the heat pipe 3 in one-step or multiple-steps manners;

(c) drawing the rod 100 to carry the coil tape from an end of the heat pipe 3 to an opposite end thereof, and installing the rolled first coil tape in the heat pipe 3, the first coil tape generating an expansion force as it unrolls and expanding against the internal diameter of the heat pipe 3; for step (b) mentioned above, resistance between each of the wick structures 30 and the heat pipe 3 is minimized and improves the manufacturing stability during step (c); and

(d) cutting off the first coil tape extending out of the heat pipe 3 for finishing installation of the wick structures 30 in the heat pipe 3, and then reducing an external diameter of the heat pipe 3 with a tube drawing process to increase compaction therebetween.

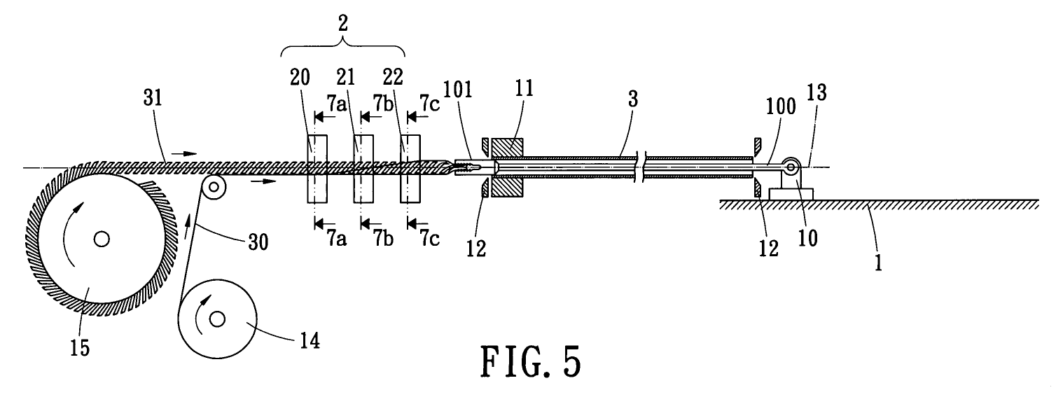

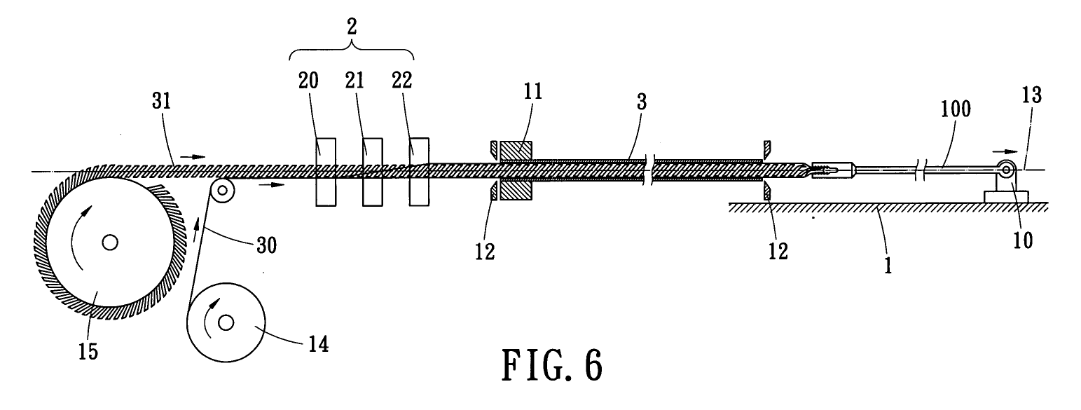

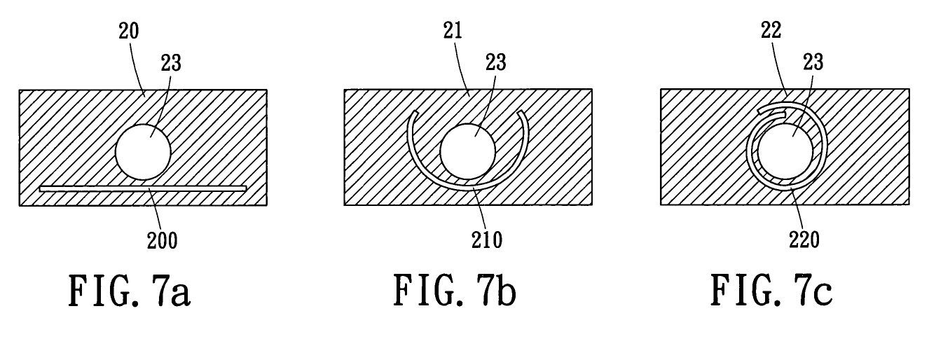

Reference is made to FIGS. 5 and 6, which illustrate a situation where a plurality of additional supporting bodies 31 are necessary. The method includes: fabricating a plurality of supporting bodies 31 into a second elongated continuous coil tape to be fed into the heat pipe 3 along with the wick structures 30, the first and second coil tapes being adjacent to and overlapping each other for the rod 100 clamping the supporting bodies 31 with the wick structures 30 and penetrating into the heat pipe 3 at the same time.

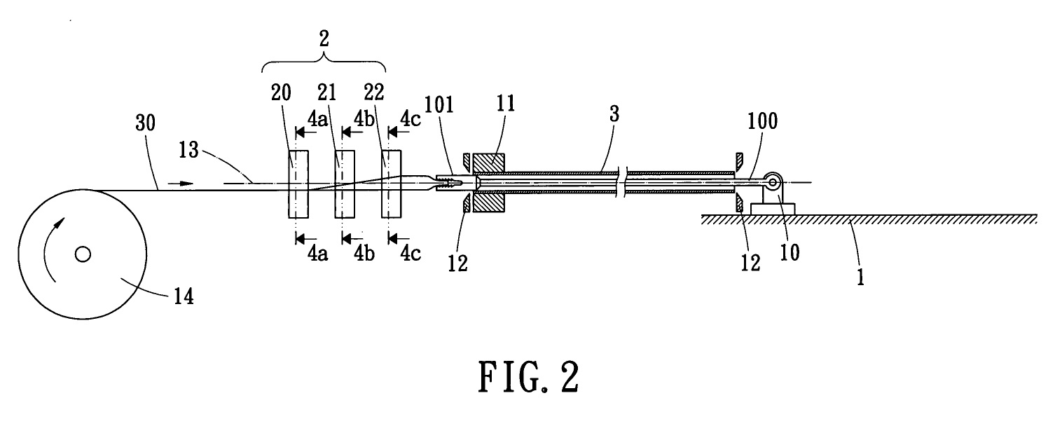

Referring to FIG. 2 and FIG. 3, the present invention provides an apparatus adopted for installing the wick structures 30 in the heat pipe 3, and the apparatus includes a base 1, a hauling mechanism 10, a fixed mechanism 11 and at least two cutting-off mechanisms 12 for completing the apparatus thereof. The base 1 is used for supporting the above-mentioned members and has a work path 13 defined overhead. The work path 13 is an imaginary track for the wick structures 30 penetrating through the heat pipe 3 in the method mentioned above. The apparatus includes a first rear 14 being adjacent to the start of the work path 13 for rolling up the first coil tape of the wick structures 30 for continuous feed. The hauling mechanism 10 is disposed on the base 1 and is movable around a termination of the work path 13. The hauling mechanism 10 has an end connecting to an end of a rod 100, which then extends along the work path 13, towards a start of the work path. 13 and has a clamping portion 101 arranged on an opposite end thereof. The clamping portion 101 therefore clamps an end the first coil tape of each of the wick structures 30 and the hauling mechanism 10 activates the rod 100 movable on the terminal thereof. The fixed mechanism 11 is disposed on the work path 13 and orients the heat pipe 3 on the work path 13 for the rod 100 to penetrate therethrough. The two cutting-off mechanisms 12 are arranged on the work path 13 and are respectively adjacent to two opposing outlets of the heat pipe 3, and are used for cutting off the first coil tape extending out from the heat pipe 3 after the wick 30 structures is completely installed in the heat pipe 3.

Moreover, as illustrated in FIGS. 5 and 6, the present invent further includes a second rear 15 rolling up the supporting bodies 31 and disposed adjacent to the start of the work path, when there is a need for supporting bodies 31. The second rear 15 and the first rear 14 are respectively disposed in a front and a rear relating to the front for feeding the wick structures 30 and supporting bodies 31 into the heat pipe 3 in a synchronal manner.

The present invention further includes a roll-forming mold 2 for rolling and narrowing the first coil tape of wick structures 30 in advance. The first coil tape is receivable in the outlet of the heat pipe 3 in an immediate or a gradual manner. The roll-forming mold 2 can include one or more modules respectively being a first module 20, a second module 21 and a third module 22 sequentially arranged between the start of the work path 13 and the heat pipe 3.

Referring to FIG. 2 and FIG. 3, an embodiment needing no supporting bodies 31 includes the first, second and the third modules 20, 21, 22 processed sequentially by the wick structures 30 to be rolled and respectively having a first aperture 200, a second aperture 210 and a third aperture 220. The first aperture 200 has a horizontal straight-line cross-section, the second aperture 210 has an arched cross-section, and the third aperture 220 has a curvilinear cross-section.

Referring to FIG. 5 and FIG. 6, another embodiment with supporting bodies 31 further includes a passageway 23 formed on each of the first, second and third modules 20, 21, 22 besides the apertures 200, 210 and 220 for bypassing the supporting bodies 31.

Accordingly, the present invention provides the method for installing heat pipe wick structures and the like to avoid damaging the wick structures 30 as in the conventional process for directly installing the wick structures 30 without rolled the same advance.

It should be apparent to those skilled in the art that the above description is only illustrative of specific embodiments and examples of the invention. The invention should therefore cover various modifications and variations made to the herein-described structure and operations of the invention, provided they fall within the scope of the invention as defined in the following appended claims.

What is claimed is:

1. A method for installing a plurality of wick structures in a heat pipe, comprising:
(a) fabricating the wick structures into a first elongated continuous coil tape, the first coil tape having a width approximately same as a circumference of an internal diameter of the heat pipe;
(b) rolling an end of the first coil tape in a width direction and clamping the end of the first coil tape to an end of a rod, which has an external diameter originally narrower than the internal diameter of the heat pipe, and narrowing the end of the first coil tape rolled to be smaller than the internal diameter of the heat pipe;
(c) drawing the rod to carry the coil tape from an end of the heat pipe to an opposite end thereof, and installing the rolled first coil tape in the heat pipe; and
(d) cutting off the first coil tape extending out of the heat pipe for finishing installation of the wick structures in the heat pipe.

2. The method of claim 1, wherein step (a) includes rolling the first coil tape on a first reel for continuous processing.

3. The method of claim 1, wherein step (a) includes fabricating a plurality of supporting bodies into a second elongated continuous coil tape to be fed into the heat pipe and currently with the wick structures, the first and second coil tapes being adjacent to and overlapping each other.

4. The method of claim 3, wherein the supporting bodies are rolled on a second reel for continuous processing.

5. The method of claim 1, wherein step (b) includes rolling and narrowing the first coil tape receivable in the outlet of the heat pipe in one-step or multiple-steps manners.

6. The method of claim 5, wherein the first coil tape is rolled by a roll-forming mold.

7. The method of claim 1, further including reducing an external diameter of the heat pipe with a tube drawing process after step (d).

8. An apparatus adopted for installing a plurality of wick structures in a heat pipe, comprising:
a base having a work path defined overhead;
a hauling mechanism disposed on the base and being movable around a termination of the work path, wherein the hauling mechanism has an end connecting to an end of a rod, the rod extending along the work path towards a start of the work path and having a clamping portion arranged on an opposite end;
a fixed mechanism disposed on the work path and orienting the heat pipe on the work path; and
at least two cutting-off mechanisms arranged on the work path and respectively being adjacent to two opposing outlets of the heat pipe.

9. The apparatus of claim 8, further including a first rear adjacent to a start of the work path.

10. The apparatus of claim 8, further including two rears adjacent to a start of the work path, the two rears respectively disposed in a front and a rear relating to the front.

11. The apparatus of claim 8, further including a roll-forming mold disposed between a start of the work path and the heat pipe.

12. The apparatus of claim 11, wherein the roll-forming mold has a first module, a second module and a third module respectively having a first aperture, a second aperture and a third aperture, wherein the first aperture has a horizontal straight-line cross-section, the second aperture has an arched cross-section, and the third aperture has a curvilinear cross-section.

13. The apparatus of claim 12, wherein the each of the first, second and third modules has a passageway formed thereon.
